(19) United States
(12) Patent Application Publication
(10) Pub. No.: US 2018/0300320 A1
(43) Pub. Date: Oct. 18, 2018

(54) NON-TRANSITORY COMPUTER-READABLE STORAGE MEDIUM, MANAGEMENT METHOD, AND MANAGEMENT APPARATUS

(71) Applicant: FUJITSU LIMITED, Kawasaki-shi (JP)

(72) Inventor: Nobuaki Takahashi, Numazu (JP)

(73) Assignee: FUJITSU LIMITED, Kawasaki-shi (JP)

(21) Appl. No.: 15/947,385

(22) Filed: Apr. 6, 2018

(30) Foreign Application Priority Data
Apr. 13, 2017 (JP) 2017-079521

(51) Int. Cl. G06F 17/30

(52) U.S. Cl. CPC G06F 17/30002; G06F 17/30445; G06F 17/30368; G06F 17/30283

(57) ABSTRACT

A non-transitory computer-readable storage medium storing a program that causes a computer to execute a process, the process including obtaining a type of updated data, included in pieces of data, to be updated in a database, the database storing the pieces of data corresponding to a plural kinds of types of data distributively in a plurality of storage devices, determining a specified storage device, from among the plurality of storage devices, to store the updated data based on management information that indicates an amount of data for each of the plural kinds of types and for each of the plurality of storage devices, storing the updated data into the specified storage device, and updating the management information upon the storing the updated data.

### CROSS-REFERENCE TO RELATED APPLICATION

This application is based upon and claims the benefit of priority of the prior Japanese Patent Application No. 2017-79521, filed on Apr. 13, 2017, the entire contents of which are incorporated herein by reference.

### FIELD

The embodiment discussed herein is related to a non-transitory computer-readable storage medium, a management method, and a management apparatus.

### BACKGROUND

Recently, the amount of data about the behavior of people and businesses, changes in social environment, and the like has been increasing. Such data is not only huge in volume but also available in variety of formats. Enabling such data to be freely handled is enormously time consuming and costly when a relational database (RDB) is used, and therefore it has been difficult to achieve this aim.

To achieve this aim, which has been difficult with an RDB, for example, a database that uses external markup language (XML) documents as data and that is schemeless and indexless is developed. In this database, a pattern matching algorithm using an automaton is used. In addition, in the database, a high-speed string matching algorithm using unidirectional sequential processing is used, providing stable search responses even when complex search conditions are given.

Related technologies are disclosed in Japanese Laid-open Patent Publication No. 2002-222194, Japanese Laid-open Patent Publication No. 6-259478, Japanese Laid-open Patent Publication No. 10-269225, and Japanese Laid-open Patent Publication No. 11-161683.

### SUMMARY

According to an aspect of the invention, an non-transitory computer-readable storage medium storing a program that causes a computer to execute a process, the process including obtaining a type of updated data, included in pieces of data, to be updated in a database, the database storing the pieces of data corresponding to a plural kinds of types of data distributively in a plurality of storage devices, determining a specified storage device, from among the plurality of storage devices, to store the updated data based on management information that indicates an amount of data for each of the plural kinds of types and for each of the plurality of storage devices, storing the updated data into the specified storage device, and updating the management information upon the storing the updated data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an entire configuration of a system in an embodiment;

FIG. 2 is a diagram illustrating an example of a management server;

FIG. 3 is a diagram illustrating an example of operation environment information;

FIG. 4 is a diagram illustrating an example of a storage server;

FIG. 5 is a diagram illustrating an example of data stored in a data storage unit;

FIG. 6 is a diagram illustrating examples of distribution of data on customers and transactions stored in storage servers;

FIG. 7 is a diagram illustrating examples of distribution of data stored in storage servers;

FIG. 8 is a diagram illustrating a first example of a search process;

FIG. 9 is a diagram illustrating a second example of the search process;

FIG. 10 is a diagram illustrating a third example of the search process;

FIG. 11 is a diagram illustrating a fourth example of the search process;

FIG. 12 is a flowchart illustrating an example of a flow of a storage process in the embodiment;

FIG. 13 is a flowchart illustrating a first example of identification processing in step S103 in FIG. 12;

FIG. 14 is a flowchart illustrating a second example of the identification processing in step S103 in FIG. 12;

FIG. 15 is a flowchart illustrating an example of a flow of a search control process in the embodiment;

FIG. 16 is a flowchart illustrating an example of a flow of a search process in the embodiment;

FIG. 17A is a diagram (1) illustrating a first example of the storage process;

FIG. 17B is a diagram (2) illustrating the first example of the storage process;

FIG. 18A is a diagram (1) illustrating a second example of the storage process;

FIG. 18B is a diagram (2) illustrating the second example of the storage process; and

FIG. 19 is a diagram illustrating an example of a hardware configuration of a management server or a storage server.

### DESCRIPTION OF EMBODIMENT

In the case where data is distributed among a plurality of storage servers, it is conceivable to search the storage servers in parallel and, upon completion of searching all of the storage servers, output the search results integrated together. For example, when unidirectional sequential processing is performed for each of the storage servers, the search times sometimes differ in accordance with the amounts of data of the storage servers. If the search times differ, a management server, which issues an instruction to perform search, will wait for a response of the slowest storage server.

In addition, the inventors found, for example, that, in the case of search of a specific type of data, when there is unevenness among the amounts of data belonging to this type, the management server will wait for a response of a storage server that is the slowest to respond to the instruction, leading to a delay in response output.

As one aspect, the present disclosure is directed toward reducing unevenness among the storage servers for the amount of data of each type.

According to one aspect, unevenness among the storage servers may be reduced for the amount of data of each type.

Example of Entire Configuration of System of Embodiment

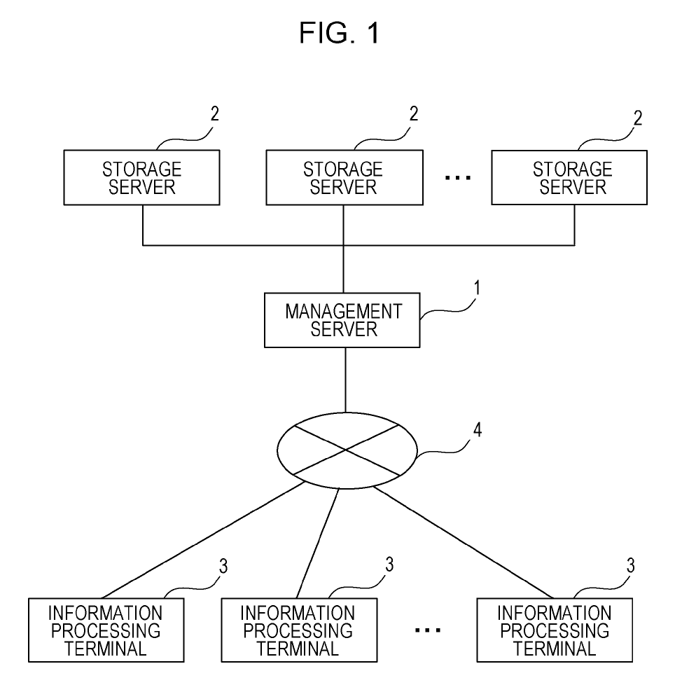

Hereinafter, an embodiment will be described with reference to the accompanying drawings. FIG. 1 is a diagram illustrating an example of an entire configuration of a system of an embodiment. As illustrated in FIG. 1, the system in the embodiment includes a management server 1, a plurality of storage servers 2, a plurality of information processing terminals 3, and a network 4.

The management server 1 stores a plurality of types of data acquired from the information processing terminals 3 or other information processing terminals and the like (not illustrated) distributively in the plurality of storage servers 2. In addition, the management server 1 is capable of communicating via a network, such as a local area network (LAN), with the storage servers 2 and manages data stored in the storage servers 2. The management server 1 is an example of a management apparatus or a computer.

In addition, the management server 1 accepts a search request (query) via the network 4 from the information processing terminal 3, and searches data in the storage servers 2 in accordance with the search request. The management server 1 then transmits search results to the information processing terminal 3.

The storage servers 2 include a database in which a plurality of types of data are registered. The database of the present embodiment is stored distributively in the plurality of storage servers 2. Data to be registered in the database includes information indicating the type of the data. The type indicates a unit used when data in the database is narrowed down based on a query.

The information processing terminal 3 is used for input of a search condition of data in the storage server 2. The information processing terminal 3 is, for example, a personal computer, a portable terminal, or the like. FIG. 1 illustrates an example of a plurality of information processing terminals 3; however, one information processing terminal 3 may be provided.

The network 4 relays communication between the management server 1 and the information processing terminals 3. The network 4 may be, for example, the Internet or a local area network (LAN).

Example of Management Server

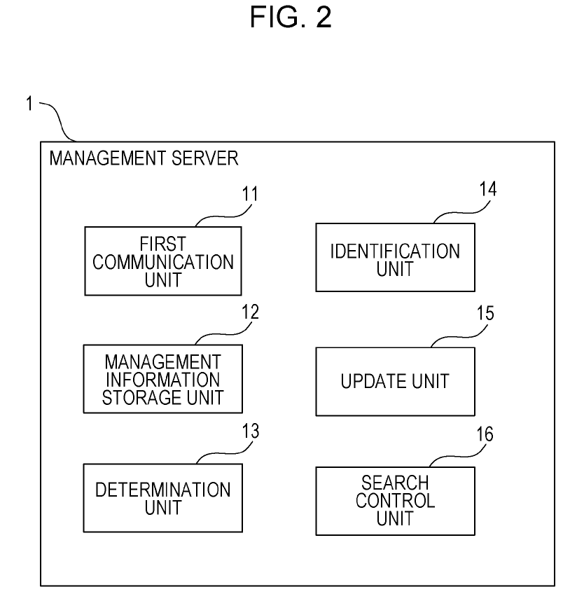

FIG. 2 is a diagram illustrating an example of the management server 1. The management server 1 includes a first communication unit 11, a management information storage unit 12, a determination unit 13, an identification unit 14, an update unit 15, and a search control unit 16.

The first communication unit 11 receives a plurality of types of data from the information processing terminals 3 or other information processing terminals and the like (not illustrated). The first communication unit 11 also receives search requests from the information processing terminals 3.

The management information storage unit 12 stores therein management information including information on the amount of data of each type for each of the plurality of storage servers 2. The management information may include distribution ratios used for data distribution to the respective storage servers 2.

The data ratio is, for example, set in advance for each type of data in accordance with the processing performance (for example, the number of clocks of a central processing unit (CPU)) of the storage server 2. For example, the higher the processing performance, the higher distribution ratio is set, and the lower the processing performance, the lower distribution ratio is set. The search speed differs in accordance with the processing performance of the storage server 2. Accordingly, the time to search data is dependent on a value obtained by dividing the amount of distributed data regarding this data by a distribution ratio. The amount of distributed data is the amount of data that has been already distributed from the management server 1 and has been stored in the storage server 2. Accordingly, the management information may include a calculation result of “the amount of distributed data÷the distribution ratio” for each type of data.

At the time of update of data in a database, the determination unit 13 acquires data targeted for the update and determines the type of the target data. The update of data includes registration of new data to the database and update of already registered data.

Note that it is assumed that data to be stored in the storage server 2 in the present embodiment is data in XML format and information indicating the type is included in the route tag of the data in XML format. Accordingly, by referencing the route tag of the target data, the determination unit 13 is able to determine the type of the target data.

The identification unit 14 identifies the storage server 2, which is the storage destination of the target data, based on management information stored in the management information storage unit 12.

By referencing management information in the management information storage unit 12, the identification unit 14 references the amount of data of the same type as that of the target data (hereinafter referred to as the target type in some cases), among data stored in each storage server 2.

The identification unit 14 then identifies, for example, the storage server 2 having the smallest amount of data of the target type as the storage destination of the target data. That is, the identification unit 14 identifies the storage server 2 as the storage destination so as to make equal the amounts of data of each type of the plurality of storage servers 2.

The identification unit 14 may identify the storage destination of the target data, based on the amounts of distributed data of each type and the processing performances of the storage servers 2, so as to make equal the times taken to search data of the target type. In order to make equal the times taken to search data of the target type, the identification unit 14 may identify the storage server 2 with the smallest value of “the distributed data amount÷the distribution ratio” of the target type as the storage destination of the target data.

When the entire amount of data of any storage server 2 is larger than the entire amount of data of at least one of other storage servers 2 by an amount greater than or equal to a predetermined acceptable threshold, the identification unit 14 may identify the storage server as the storage destination so as to make equal the entire amounts of data of the plurality of storage servers 2. For example, the identification unit 14 may identify the storage server 2 in which the entire amount of data is smallest, as the storage destination of target data.

When the amount of data of any storage server 2 is larger than the amount of data of at least one of other storage servers 2 by an amount greater than or equal to a predetermined accessible threshold, the identification unit 14 may identify the storage server 2 as the storage destination based on the entire amounts of data and the processing performances of the plurality of storage servers 2. For example, the identification unit 14 may identify the storage server 2 with the smallest value of “the amount of distributed data÷the distribution ratio” for the entire data as the storage destination of the target data.

The update unit 15 stores the target data in the storage server 2 identified by the identification unit 14 and updates management information of the management information storage unit 12. The update unit 15, for example, transmits the target data via the first communication unit 11 to the identified storage server 2 and adds information on the target data to the management information.

The search control unit 16 accepts a search request via the first communication unit 11 from the information processing terminal 3 and recognizes the type of data to be searched for from search conditions included in the search request. The search control unit 16 then transmits instruction information for searching for data of the target type to the plurality of storage servers 2.

The search control unit 16 transmits instruction information to the plurality of storage servers 2 in response to the acquired search request to search, in parallel, data stored in the plurality of storage servers 2. The search control unit 16 performs parallel search on the plurality of storage servers 2 to reduce the search time.

If the search control unit 16 has received search requests from the plurality of information processing terminals 3, the search control unit 16 may integrate the plurality of search requests and perform a search process. Then, upon receiving a search result from the storage server 2, the search control unit 16 distributes the search result to the plurality of information processing terminals 3. The search control unit 16 integrates search requests, thereby enabling the processing time to be inhibited from increasing with an increase of search requests.

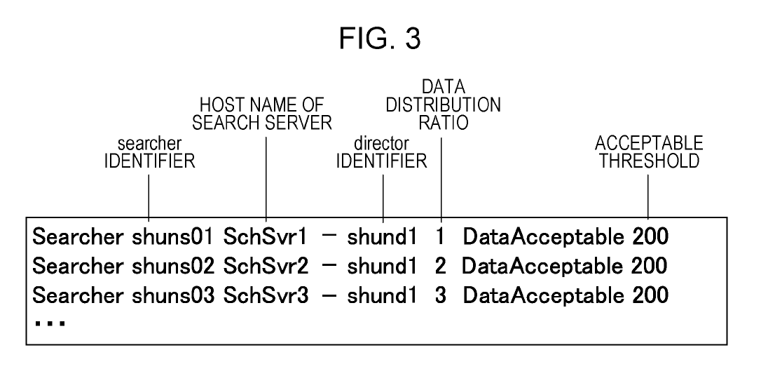

FIG. 3 is a diagram illustrating an example of operation environment information. The operation environment information illustrated in FIG. 3 is part of management information stored in the management information storage unit 12. The operation environment information illustrated in FIG. 3 includes searcher identifiers, host names of storage servers 2, director identifiers, data distribution ratios, and accessible thresholds.

The searcher identifier is an identifier indicating the operation environment of the storage server 2. The director identifier is an identifier indicating the operation environment of the management server 1.

Note that the management information includes, in addition to the operation environment information illustrated in FIG. 3, the amount of data of each type and the calculation result of “the amount of distributed data÷the distribution ratio” as described above.

Example of Storage Server

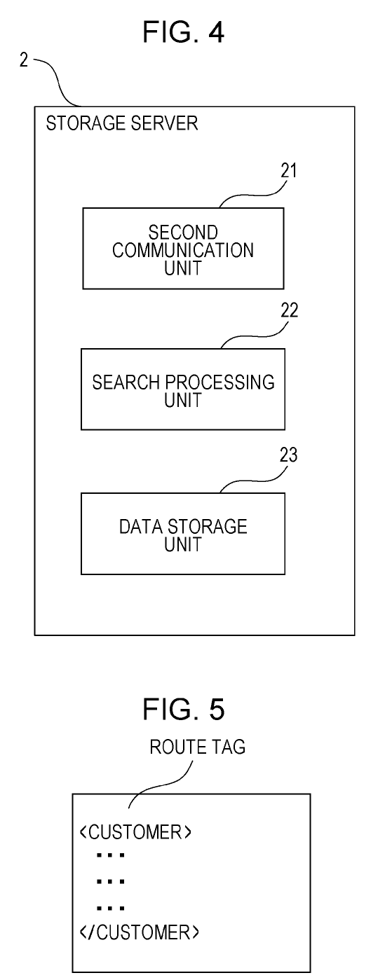

FIG. 4 is a diagram illustrating an example of the storage server 2. The storage server 2 includes a second communication unit 21, a search processing unit 22, and a data storage unit 23.

The second communication unit 21 receives the target data transmitted from the management server 1 in a storage process. The second communication unit 21 also receives instruction information for requesting search from the management server 1 in a search process.

The search processing unit 22 searches data stored in the data storage unit 23 in accordance with instruction information received from the management server 1. Use of a high-speed string matching algorithm using unidirectional sequential processing, for example, for search of the search processing unit 22 enables stable search responses to be obtained even when complex search conditions are given. Note that the search processing unit 22 may perform search by a method other than the high-speed string matching algorithm using unidirectional sequential processing. The search processing unit 22 uses, for example, a search method of sequentially referencing each piece of data without using an index or the like.

The data storage unit 23 stores therein data transmitted from the management server 1. As described above, the target data to be stored is assumed to be, for example, data in XML format.

FIG. 5 is a diagram illustrating an example of data stored in the data storage unit 23. As illustrated in the example in FIG. 5, data stored in the data storage unit 23 is data described in XML format, and the type of data is described in the head route tag.

Note that data used in the present embodiment is not limited to data in XML format. For example, data in which the type of data is described at a predetermined position and whose type is able to be identified without reading all of the data may be used.

In the case where data illustrated in the example in FIG. 5 is used, the search processing unit 22 is able to determine whether the referenced data is data of the target type, by referencing the head route tag without reading the entire target data. If the referenced data is of the target type, the search processing unit 22 reads, for example, the portion from the route tag (<customer>) to a tag (</customer>) indicating completion, while if the referenced data is not of the target type, the search processing unit 22 skips over the portion after the route tag.

Examples of Data Distribution of Storage Server

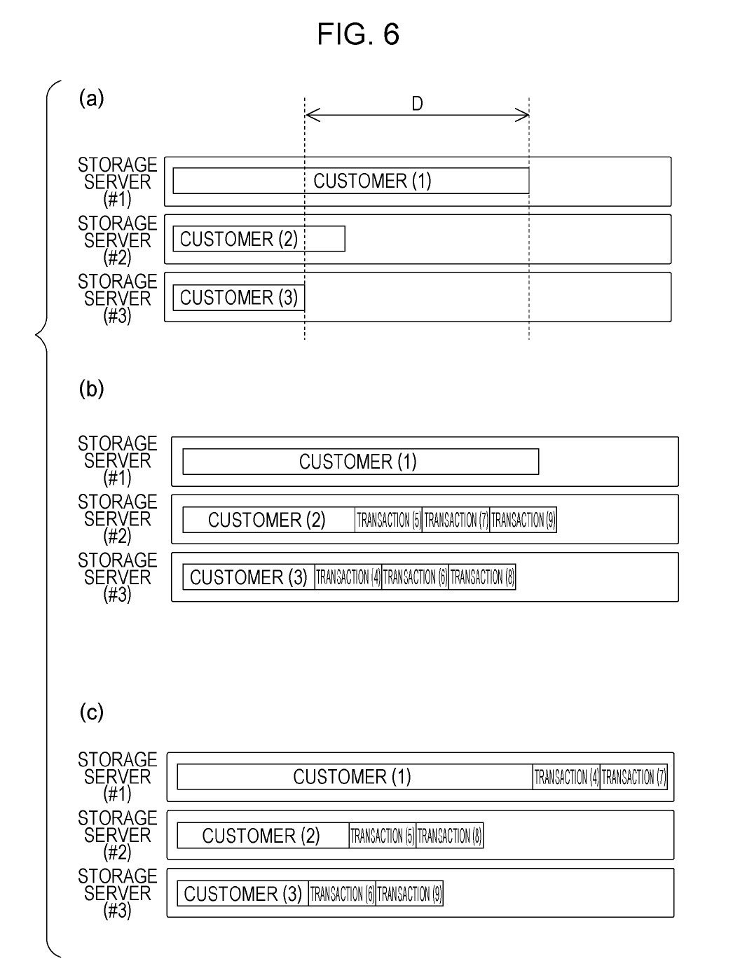

FIG. 6 illustrates examples of distribution of data on customers and transactions stored in the storage servers 2. In the example illustrated in FIG. 6(a), customer data, the amounts of which differ from each other, is stored in the storage servers 2. Additionally, in FIG. 6(a), a difference D between the amount of data of the storage server 2 (#1) in which the largest amount of data is stored and the amount of data of the storage server 2 (#3) in which the smallest amount of data is stored is illustrated.

In the example illustrated in FIG. 6(b), it is assumed that, after the customer data illustrated in FIG. 6(a) has been stored, transaction data is stored such that the entire amounts of data of all the storage servers 2 are equal. As illustrated in FIG. 6(b), the difference in the amount of data among the storage servers 2 is small but the amounts of data for transaction data are uneven.

In the example illustrated in FIG. 6(c), it is assumed that, after customer data illustrated in FIG. 6(a) has been stored, transaction data is stored such that the amounts of data of each type of the plurality of storage servers 2 are equal. As illustrated in FIG. 6(c), data is stored such that the amounts of data of all the storage servers 2 are equal for transaction data.

As described above, when the amount of data of any storage server 2 is larger than the amount of data of at least one of other storage servers 2 by an amount greater than or equal to a predetermined acceptable threshold, the identification unit 14 identifies the storage server 2 in which the target data is to be saved so as to make equal the entire amounts of data of the storage servers 2.

In the example illustrated in FIG. 6(a), if the difference D is greater than or equal to an acceptable threshold, the identification unit 14 stores transaction data in the storage servers 2 other than the storage server 2 (#1). If the difference D is less than the acceptable threshold, data is stored such that the amounts of data are equal for transaction data as illustrated in FIG. 6(c).

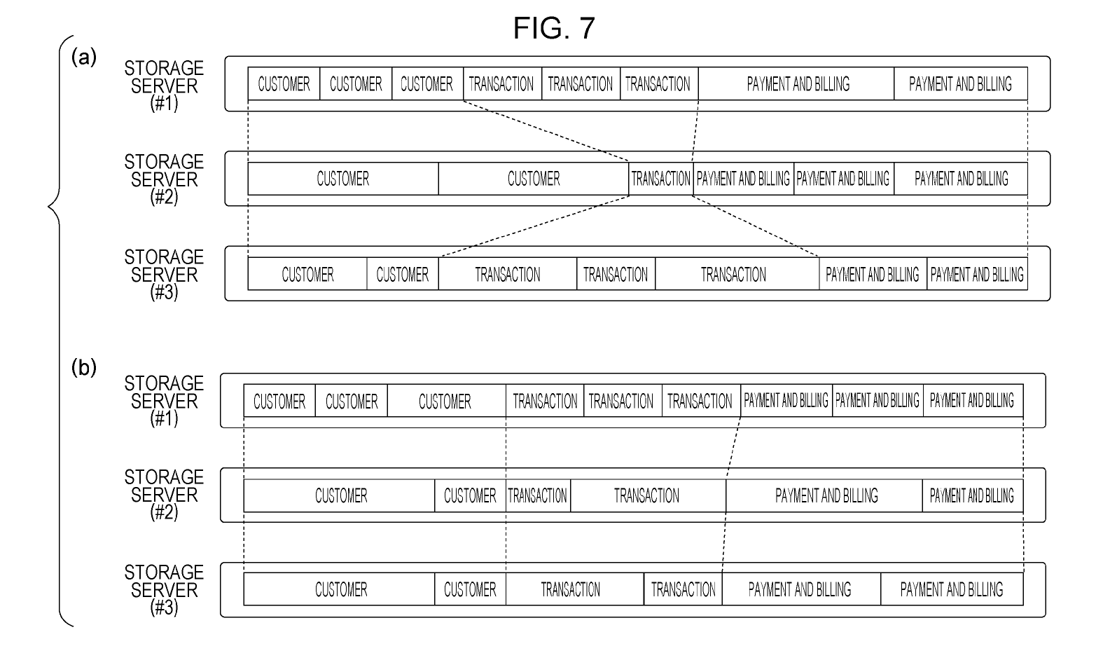

FIG. 7 is a diagram illustrating examples of distribution of data stored in the storage servers 2. FIG. 7(a) illustrates an example in which each type of data is stored such that the entire amounts of data of all the storage servers 2 are equal. In the example in FIG. 7(a), although the entire amounts of data of all the storage servers 2 are equal, the differences in the amount of each type of data are large.

FIG. 7(b) illustrates an example in which each type of data is stored such that the amounts of each type of data of all the storage servers 2 are equal. In the example in FIG. 7(b), the differences in the amount of each type of data among the storage servers 2 are small compared with the example in FIG. 7(a). Note that, in the example illustrated in FIG. 7(b), it is assumed that data is stored under the condition that the distribution ratio included in management information is one.

First Example of Search Process

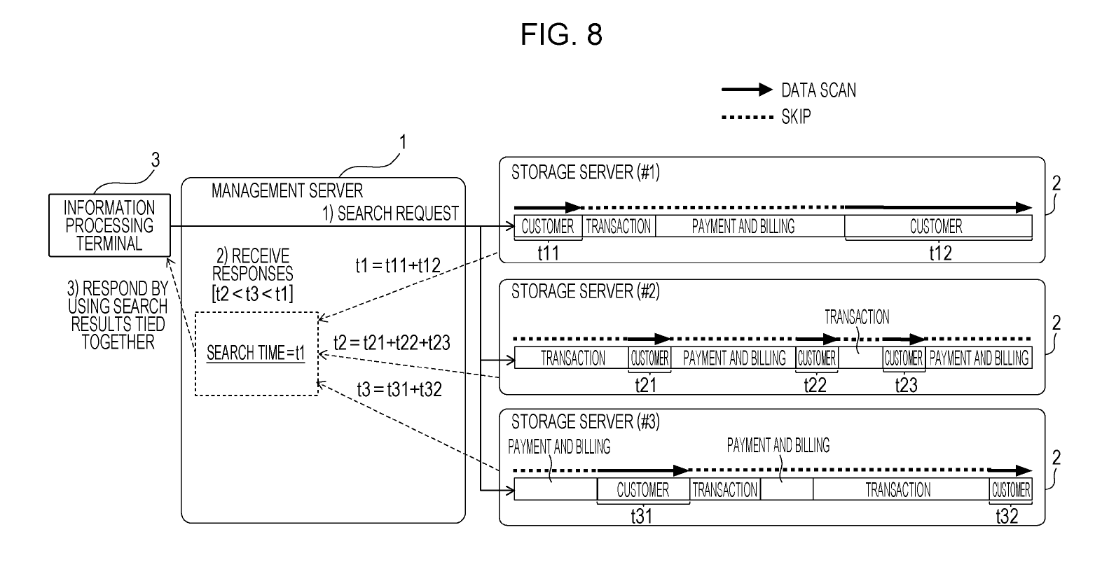

FIG. 8 is a diagram illustrating a first example of the search process. In the first example, it is assumed that the management server 1 receives a search request from one information processing terminal 3. In addition, in FIG. 8, it is assumed that each storage server 2 has the same performance.

The search control unit 16 of the management server 1 recognizes the type of data to be searched for by using search conditions included in the search request. The search control unit 16 simultaneously transmits instruction information for searching for data of the recognized type to a plurality of storage servers 2 (#1, #2, #3) to perform parallel search of the plurality of storage servers 2. In the example illustrated in FIG. 8, the type of data to be searched for is assumed to be “customer”.

The search processing units 22 of the plurality of storage servers 2 search for data of the type of “customer” in accordance with instruction information transmitted from the management server 1. As described above, data stored in the storage server 2 is in XML format, and the type of data is described in the route tag. Therefore, the search processing unit 22 scans data with the route tag name “customer” and skips over the other data.

In the example illustrated in FIG. 8, the time taken to search the storage server 2 (#1) is t11+t12=t1. In addition, the time taken to search the storage server 2 (#2) is t21+t22+t23=t2. In addition, the time taken to search the storage server 2 (#3) is t31+t32=t3. In the example illustrated in FIG. 8, since the amounts of data of the storage servers 2 are different for customer data, t1, t2, and t3 are times different from one another.

The management server 1 waits to receive responses indicating search results from all of the storage servers 2. Upon receiving a response indicating a search result from each storage server 2, the management server 1 then responds to the information processing terminal 3 by using the search results from the storage servers 2 tied together.

In the example illustrated in FIG. 8, if t2<t3<t1 holds, the time taken for search is t1, which is the longest search time among the search times of all the storage servers 2. The search time of each storage server 2 depends on the amount of data, and therefore the greater the unevenness in the amount of data of the target type among the storage servers 2, the larger the difference in search time. Further, the larger the difference in search time, the longer the time taken from receipt of a search request from the information processing terminal 3 to issuance of a response.

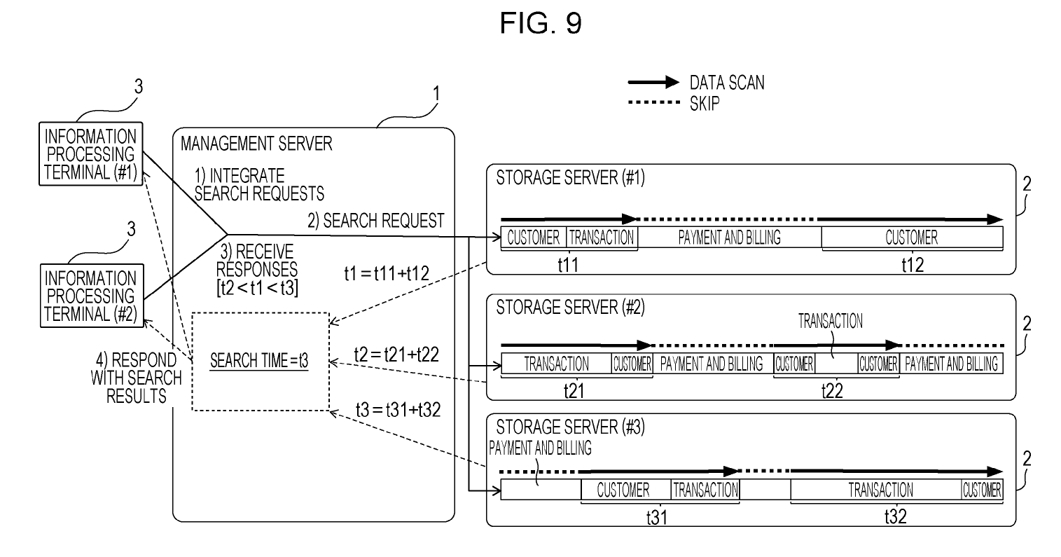

FIG. 9 is a diagram illustrating a second example of the search process. In the second example, it is assumed that the management server 1 receives search requests from two information processing terminals 3. In addition, in FIG. 9, it is assumed that each storage server 2 has the same performance.

In the example illustrated in FIG. 9, since search requests are received from a plurality of information processing terminals 3, the search control unit 16 integrates the search requests. Then, the search control unit 16 of the management server 1 recognizes the type of data to be searched for from search conditions included in a search request. In the example illustrated in FIG. 9, the type included in a search request from the information processing terminal 3 (#1) is assumed to be “customer”, and the type included in a search request from the information processing terminal 3 (#2) is assumed to be “transaction”.

Further, the search control unit 16 simultaneously transmits instruction information for searching for data of the type of “customer” or “transaction” to a plurality of storage servers 2 (#1, #2, #3) to perform parallel search of the plurality of storage servers 2.

The search processing units 22 of the plurality of storage servers 2 search data of the type of “customer” or “transaction” in accordance with the instruction information transmitted from the management server 1. As described above, data stored in the storage server 2 is in XML format, and the type is described in the route tag. Therefore, the search processing unit 22 scans data with the route tag name of “customer” or “transaction” and skips over the other data

In the example illustrated in FIG. 9, the time taken for searching the storage server 2 (#1) is t11+t12=t1. Since, as described above, the search processing unit 22 searches for data of the type of “customer” or “transaction”, for example, t11 and t12 is the total time of the search time for the type of “customer” and the search time for the type of “transaction”.

In addition, the time taken for searching the storage server 2 (#2) is t21+t22=t2. In addition, the time taken for searching the storage server 2 (#3) is t31+t32=t3.

The management server 1 waits to receive responses indicating search results from all of the storage servers 2. Upon receiving a response indicating a search result from each storage server 2, the management server 1 transmits a search result for “customer” to the information processing terminal 3 (#1) and transmits a search result for “transaction” to the information processing terminal 3 (#2).

In the example illustrated in FIG. 9, if t2<t1<t3 holds, the time taken for search is t3, which is the longest search time among the search times of all the storage servers 2. As in the first example, the search time of each storage server 2 depends on the amount of data, and therefore the greater the unevenness in the amount of data of the target type among all the storage servers 2, the larger the difference in search time. Further, the larger the difference in search time, the longer the time taken from receipt of a search request from the information processing terminal 3 to issuance of a response.

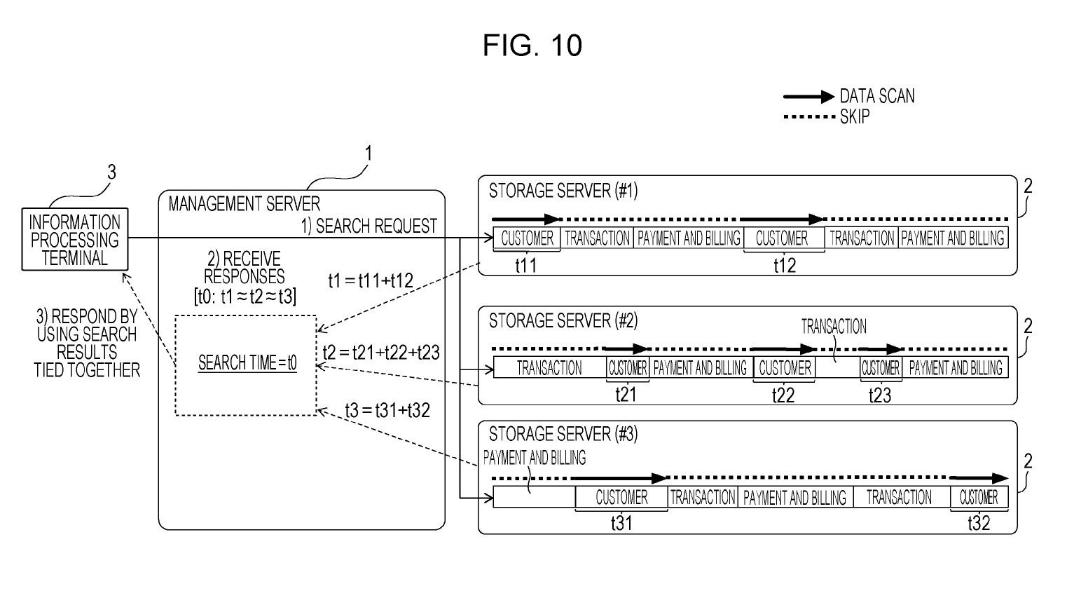

FIG. 10 is a diagram illustrating a third example of the search process. The system configuration and the search procedure illustrated in FIG. 10 are similar to those in the first example illustrated in FIG. 8, and therefore detailed description thereof is omitted. Although, in the example illustrated in FIG. 8, the amounts of data of all the storage servers 2 differ for the customer data, it is assumed in the example illustrated in FIG. 10 that the amounts of data of all the storage servers 2 are approximately the same for the customer data. Since the amounts of data of all the storage servers 2 are approximately the same for the customer data, the search times t1, t2, and t3 of the storage servers 2 are also approximately the same.

Since, as described above, the management server 1 waits to receive responses indicating search results from all of the storage servers 2, the time taken for search is the same as the longest search time among the search times of the storage servers 2. Accordingly, if there is a small difference in the total amount of data for each type, the search time in the case where unevenness in data among all the storage servers 2 is small as in the case in FIG. 10 is shorter than the search time in the case where unevenness in data among all the storage servers 2 is large.

Note that, likewise, even when search requests are received from a plurality of information processing terminals 3 and the search requests are integrated as in the example illustrated in FIG. 9, a search time t0 of the case with small unevenness in data among all the storage servers 2 is short as compared with the case where the unevenness in data is large.

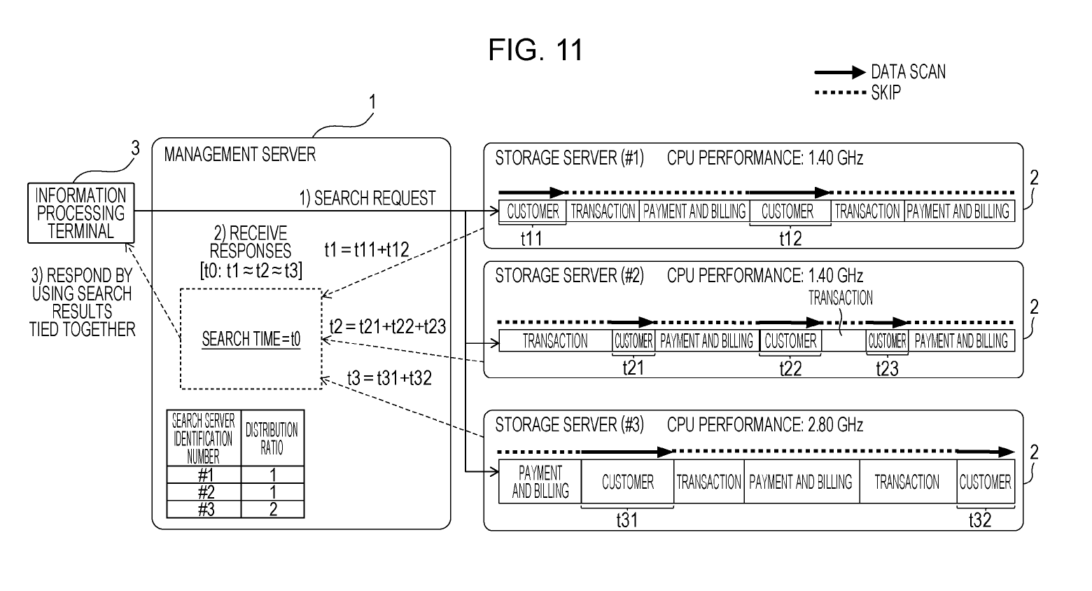

FIG. 11 is a diagram illustrating a fourth example of the search process. The system configuration and the search procedure illustrated in FIG. 11 are similar to those in the first example illustrated in FIG. 8, and therefore detailed description thereof is omitted. The example illustrated in FIG. 11 differs from the example illustrated in FIG. 8 in that the CPU performance (the number of clocks) of each storage server 2 is explicitly indicated.

The CPU performances of the storage server 2 (#1) and the storage server 2 (#2) are each 1.40 GHz, and the CPU performance of the storage server 2 (#3) is 2.80 GHz. That is, the CPU performance of the storage server 2 (#3) is double the CPU performance of the storage server 2 (#1) or the storage server 2 (#2).

The search speed is considered to be proportional to the CPU performance, and therefore the search speed of the storage server 2 (#3) is double the search speed of the storage server 2 (#1) or the storage server 2 (#2). However, data has been accumulated according to the distribution ratio in accordance with the CPU performance, and, as a result, the amount of data of the storage server 2 (#3) is approximately double the amount of data of the storage server 2 (#1) or the storage server 2 (#2). Accordingly, the search times t1, t2, and t3 of the storage servers 2 are approximately the same and therefore the wait time is short, and the search time t0 is short compared with the example illustrated in FIG. 8.

Example of Flow of Storage Process in Embodiment

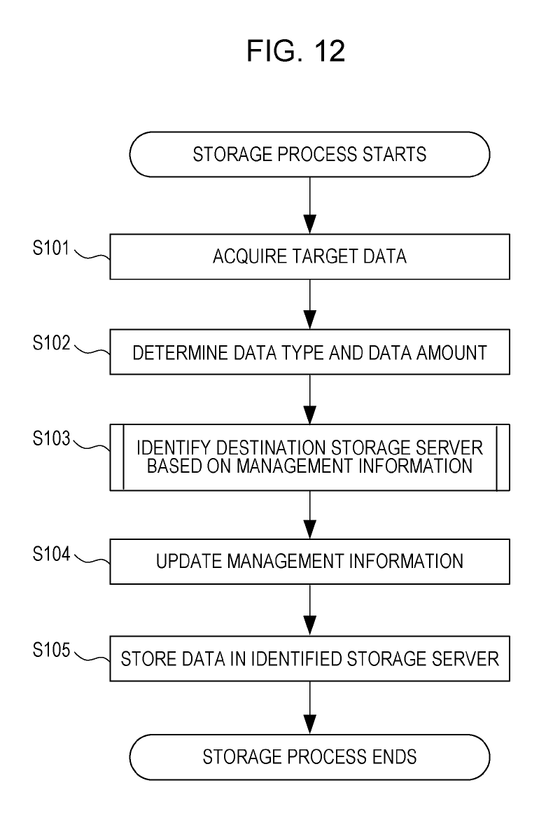

FIG. 12 is a flowchart illustrating an example of a flow of a storage process in the embodiment. The determination unit 13 acquires data to be stored (step S101).

At the time of update of data in a database, the determination unit 13 determines the type and the amount of data targeted for the update (step S102). The determination unit 13 determines the type of the target data by referencing, in the target data, a portion where the type is described. In the case where the target data is in XML format, for example, the determination unit 13 determines the type of the target data by referencing the route tag.

The identification unit 14 identifies a destination storage server (storage server 2) in which target data is to be saved, based on management information being stored in the management information storage unit 12 and including information on the amount of each type of data (step S103). Detailed processing in step S103 will be described below.

The update unit 15 updates the management information in the management information storage unit 12 (step S104). The update unit 15, for example, adds information on the target data to the management information or updates the management information with information on the target data.

The update unit 15 stores the target data in the storage server 2 identified by the identification unit 14 (step S105). The update unit 15 stores the target data in the storage server 2, for example, by transmitting the target data via the first communication unit 11 to the identified storage server 2.

As described above, the identification unit 14 identifies the storage server 2, which is the storage destination of the target data, based on the management information in which the amount of data is recorded type by type, and therefore the unevenness among all the storage servers 2 may be reduced for the amount of data of each type. Accordingly, as in the examples in FIG. 10 and FIG. 11, the management server 1 is able to make equal the search times of the storage servers 2 to decrease the search time.

For example, it is conceivable to increase the number of storage servers 2 to disperse data to be stored in order to reduce unevenness in the amount of data among the storage servers 2; however, cost in hardware, software, running, maintenance, and the like increases. The management server 1 in the present embodiment may reduce unevenness among the storage servers 2 for the amount of data of each type without increasing cost.

First Example of Identification Processing

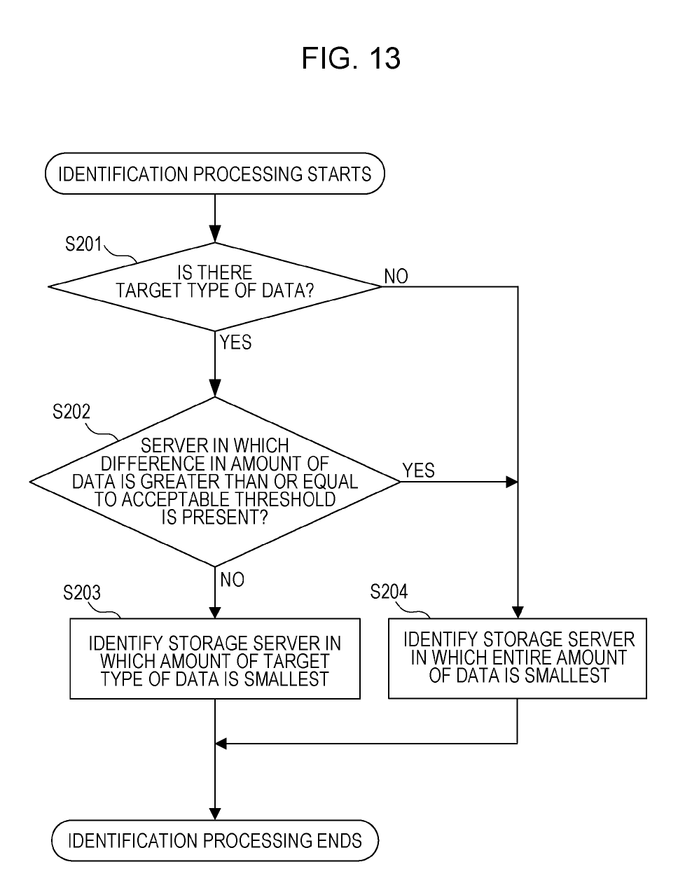

FIG. 13 is a flowchart illustrating a first example of identification processing in step S103 in FIG. 12. In the first example, it is assumed that distribution ratios in accordance with the processing performances of the storage servers 2 are not set.

By referencing the management information, the identification unit 14 determines whether there is data of the target type in at least one storage server 2 (step S201).

If Yes in step S201, the identification unit 14 determines whether the storage server 2 in which the difference in the entire amount of data is greater than or equal to the acceptable threshold is present (step S202). That is, the identification unit 14 determines whether the entire amount of data of any storage server 2 is larger than the entire amount of data of at least one of other storage servers 2 by an amount greater than or equal to a predetermined acceptable threshold.

If No in step S202, the identification unit 14 identifies the storage server 2 in which the amount of data of the target type is smallest, as the storage destination of the target data (step S203). That is, the identification unit 14 identifies the storage server 2 in which the target data is to be saved so as to make equal the amounts of data of the target type of the plurality of storage servers 2.

If No in step S201 or Yes in step S202, the identification unit 14 identifies the storage server 2 in which the entire amount of data is smallest, as the storage destination of the target data (step S204). That is, the identification unit 14 identifies the storage server 2, which is the storage destination of the target data, so as to make equal the entire amounts of data of the plurality of storage servers 2.

As described above, in the first example, since, in step S203, the identification unit 14 identifies the storage server 2 as the storage destination of the target data so as to make equal the amounts of data of the target type, unevenness among storage servers may be reduced.

In addition, if the difference in the entire amount of data of the storage server 2 is greater than or equal to the acceptable threshold, the identification unit 14, in step S204, identifies the storage server 2 whose entire amount of data is smallest, as the storage destination of the target data.

Accordingly, the difference in the entire amount of data among all the storage servers 2 may be inhibited from increasing. Accordingly, the management server 2 may reduce the possibility that, for example, the amount of data exceeds the processable memory amount of the storage server 2.

Second Example of Identification Processing

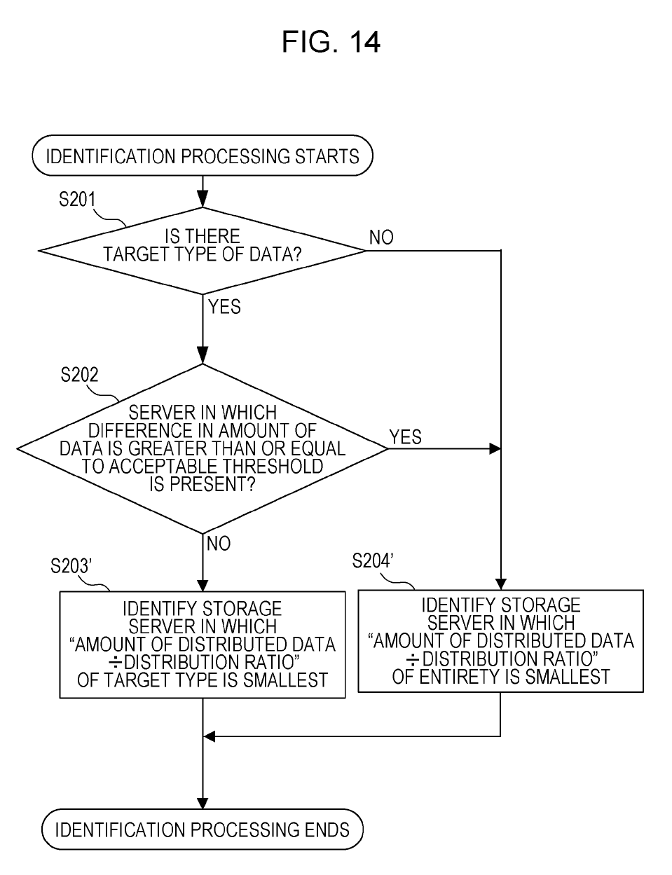

FIG. 14 is a flowchart illustrating a second example of the identification processing in step S103 in FIG. 12. In the second example, it is assumed that distribution ratios in accordance with the processing performances of the storage servers 2 are set. The process in step S201 and S202 is the same as that illustrated in FIG. 13, and description thereof is omitted.

If No in step S202, the identification unit 14 identifies the storage server 2 in which the value of “the amount of distributed data÷the distribution ratio” of the target type is smallest, as the storage destination of the target data (step S203′).

The distribution ratios are set in accordance with the processing performances of the storage servers 2. That is, the identification unit 14 identifies a destination storage server in which the target data is to be stored, based on the amounts of data of each type of the plurality of storage servers 2 and the processing performances of the plurality of storage servers 2 included in the management information. In addition, the value of “the amount of distributed data÷the distribution ratio” corresponds to the search time, and therefore the management server 1 is able to make equal the search times in all the storage servers 2 in a search process described below.

If No in step S201 or Yes in step S202, the identification unit 14 identifies the storage server 2 in which the value of “the amount of distributed data÷the distribution ratio” is smallest for the entire data, as the storage destination of the target data (step S204′). That is, the identification unit 14 identifies a destination storage server in which the target data is to be stored, based on the entire amounts of data of the plurality of storage servers and the processing performances of the plurality of storage servers.

As described above, in the second example, with the processing performances of the storage servers 2 taken into account, the identification unit 14 identifies the storage server 2, which will become the storage destination of the target data, so as to make equal the search times of data of the target type. For example, at the time of adding storage servers 2 after the system operation has started, it is sometimes difficult to match the processing performance of the existing storage server 2 and the processing performance of the storage server 2 to be added. The management server 1 may reduce the search time by storing data in the storage servers 2 such that their search times for data of the target type are equal even when all the storage servers 2 have different processing performances.

Example of Flow of Search Process in Embodiment

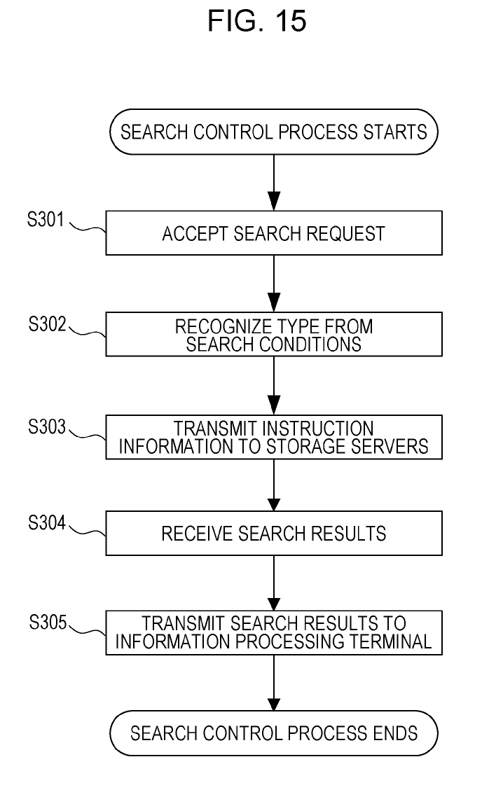

FIG. 15 is a flowchart illustrating an example of a flow of a search control process in the embodiment. The search control unit 16 of the management server 1 accepts a search request via the first communication unit 11 from the information processing terminal 3 (step S301). The search control unit 16 then recognizes the type of data to be searched for from search conditions included in the search request (step S302).

The search control unit 16 transmits instruction information in accordance with the search conditions to the plurality of storage servers 2 (step S303). The search control unit 16 receives search results from the plurality of storage servers 2 to which the instruction information has been transmitted (step S304). The search control unit 16 then transmits the received search results to the information processing terminal 3 that is the transmission source of the search request (step S305).

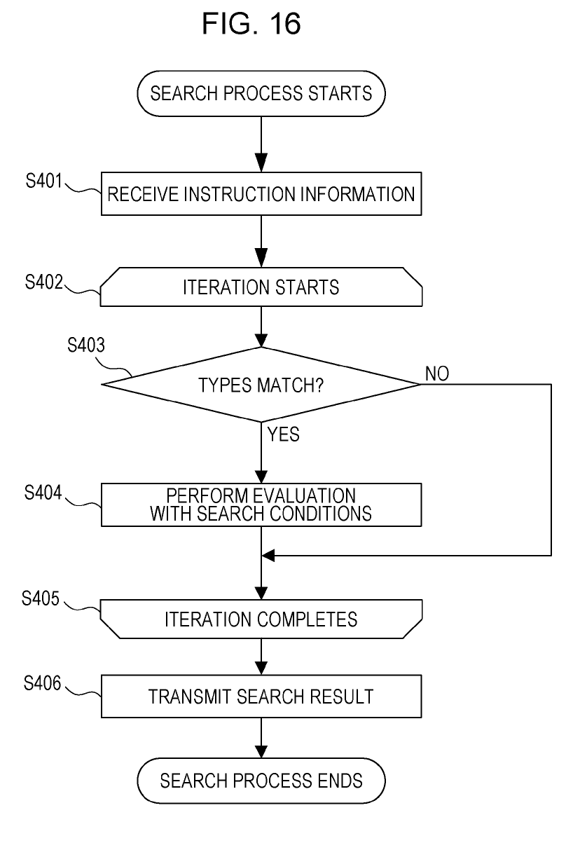

FIG. 16 is a flowchart illustrating an example of a flow of a search process in the embodiment. The process illustrated in FIG. 16 is a process at the time when the storage server 2 receives search instruction information from the management server 1.

The second communication unit 21 receives instruction information for requesting search from the management server 1 (step S401). In order to search data stored in the data storage unit 23 in accordance with the instruction information received from the management server 1, the search processing unit 22 begins an iterative operation (step S402).

The search processing unit 22 determines whether the type included in the instruction information matches the type of the record in question (step S403). The search processing unit 22, for example, determines whether the route tag name of XML format data matches the type included in the instruction information.

If Yes in step S403, it is evaluated whether the record in question meets the search conditions (step S404). If No in step S403, the record in question is not scanned but is skipped over.

That is, the search processing unit 22 scans or skips over one piece of XML format data in one iterative operation.

The search processing unit 22 performs the process in steps S403 and S404 for all records and then completes the iterative operation (step S405). The search processing unit 22 then transmits search results via the second communication unit 21 to the management server 1 (step S406).

First Example of Storage Process

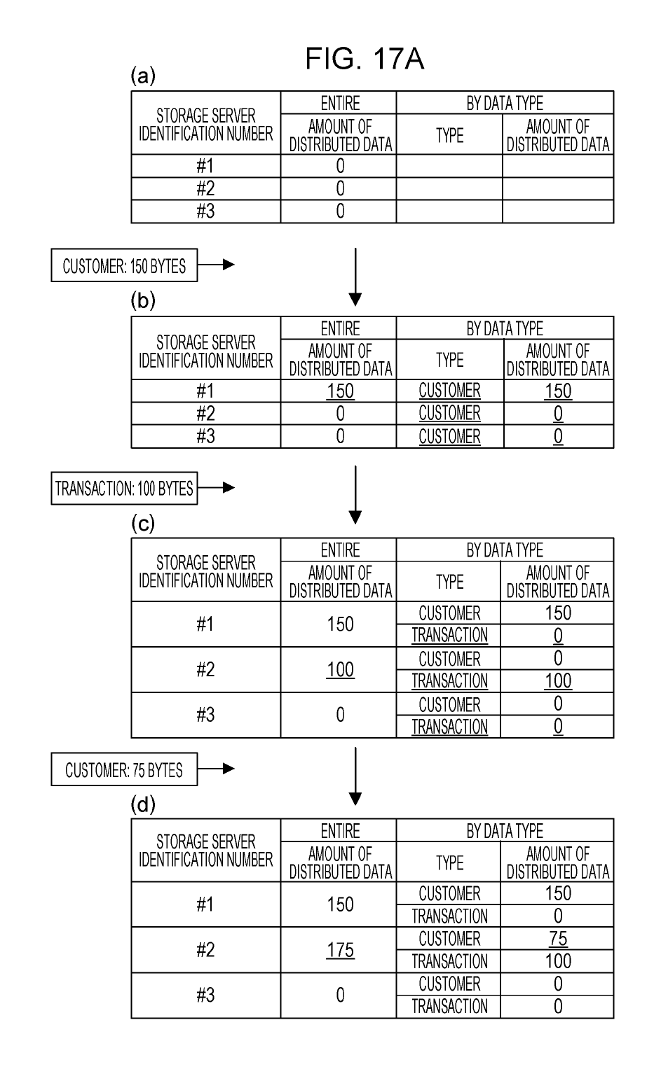

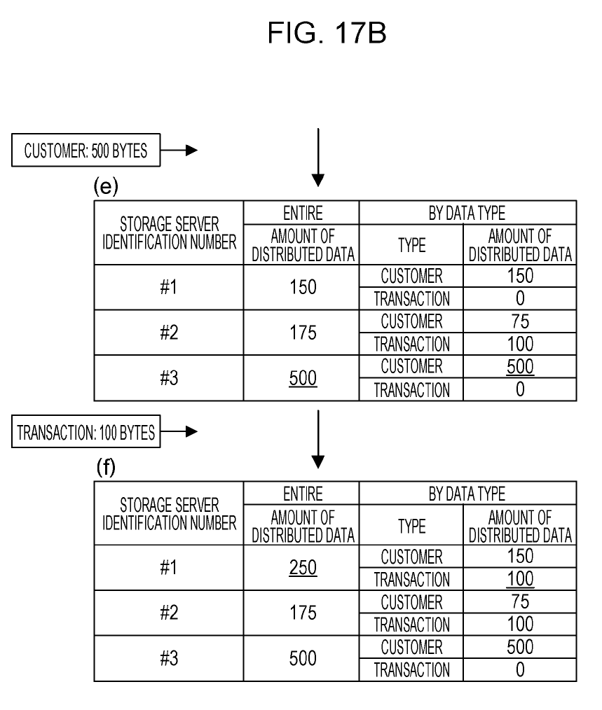

FIG. 17A and FIG. 17B are diagrams illustrating a first example of the storage process. FIG. 17A and FIG. 17B illustrate an example in which the storage process illustrated in FIG. 12 is performed. The acceptable threshold of a data difference used in the process in step S202 is assumed to be 300 bytes.

FIG. 17A and FIG. 17B illustrate transitions of management information and the type and amount of data to be stored. The management information illustrated in FIG. 17A and FIG. 17B includes the identification numbers of the storage servers 2, the amounts of distributed data for the entire data, and the amounts of distributed data for individual types of data. Note the underlined portions in the management information indicate updated items.

The management information illustrated in (a) indicates the state in which data is not stored in any storage server 2. For example, it is then assumed that the management server 1 has acquired 150 bytes of customer data.

There is no data of the target type in any storage server 2 before the management server 1 acquires the above customer data (No in step S201), and therefore the process in step S204 is performed. Since the amounts of distributed data of all of the storage servers 2 are zeros as described above, in the present embodiment, in the process in step S204, the identification unit 14 identifies the storage server 2 (#1) with a smaller identification number as the storage destination. Then, the management information becomes a state illustrated in (b).

It is then assumed that the management server 1 has acquired 100 bytes of transaction data. There is no data of the target type (No in step S201), and therefore the process in step S204 is performed. In the process in step S204, the identification unit 14 identifies either the storage server 2 (#2) or the storage server 2 (#3) in which the entire amount of data is smallest. In the present embodiment, the identification unit 14 identifies the storage server 2 (#2) with a smaller identification number as the storage destination. Then, the management information becomes a state illustrated in (c).

It is then assumed that the management server 1 has acquired 75 bytes of customer data. There is data of the target type (Yes in step S201), and the server 2 in which the data difference is greater than or equal to the acceptable threshold is not present (No in step S202), and therefore the process in step S203 is performed.

In step S203, the identification unit 14 identifies either the storage server 2 (#2) or the storage server 2 (#3) in which the amount of distributed data of the target type is smallest, as the storage destination. In the present embodiment, the identification unit 14 identifies the storage server 2 (#2) with a smaller identification number as the storage destination. Then, the management information becomes a state illustrated in (d).

It is then assumed that the management server 1 has acquired 500 bytes of customer data. There is data of the target type (Yes in step S201) and the storage server 2 in which the data difference is greater than or equal to the acceptable threshold is not present (No in step S202), and therefore the process in steps S203 is performed. In step S203, the amount of distributed data of the target type is smallest in the storage server 2 (#3), and therefore the identification unit 14 identifies the storage server 2 (#3) as the storage destination. Then, the management information becomes a state illustrated in (e)

It is then assumed that the management server 1 has acquired 100 bytes of transaction data. There is data of the target type (Yes in step S201), and a determination in step S202 is performed. The difference in the entire amount of data between the storage server 2 (#3) and the storage server 2 (#2) is greater than or equal to 300 bytes, which is the acceptable threshold, and therefore the determination result is Yes in step S202 and the process in step S204 is performed. In step S204, the identification unit 14 identifies the storage server 2 (#1) in which the entire amount of distributed data is smallest, as the storage destination. Then, the management information becomes a state illustrated in (f).

Second Example of Storage Process

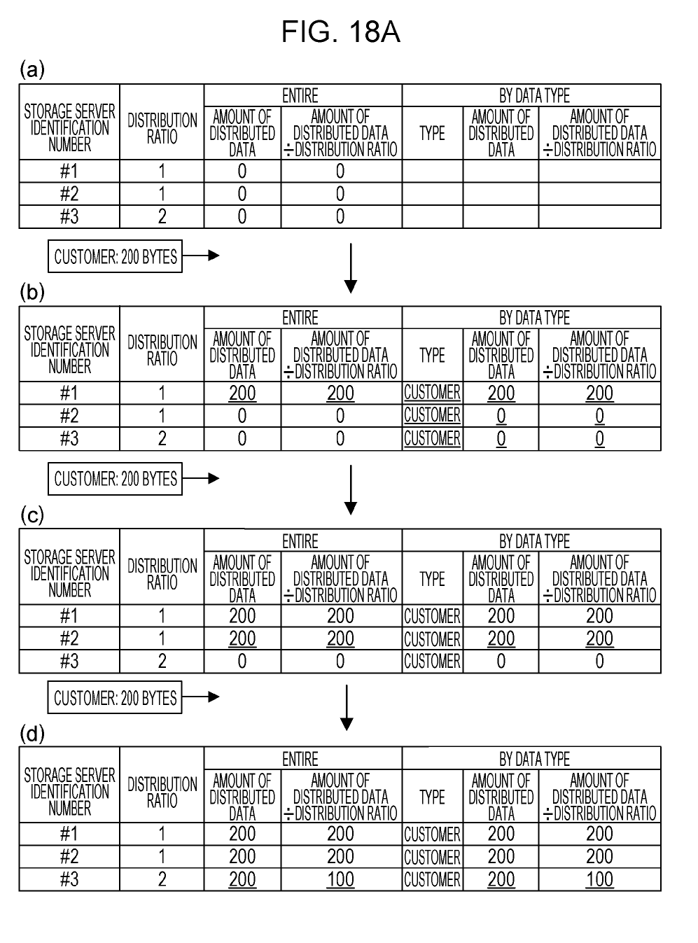

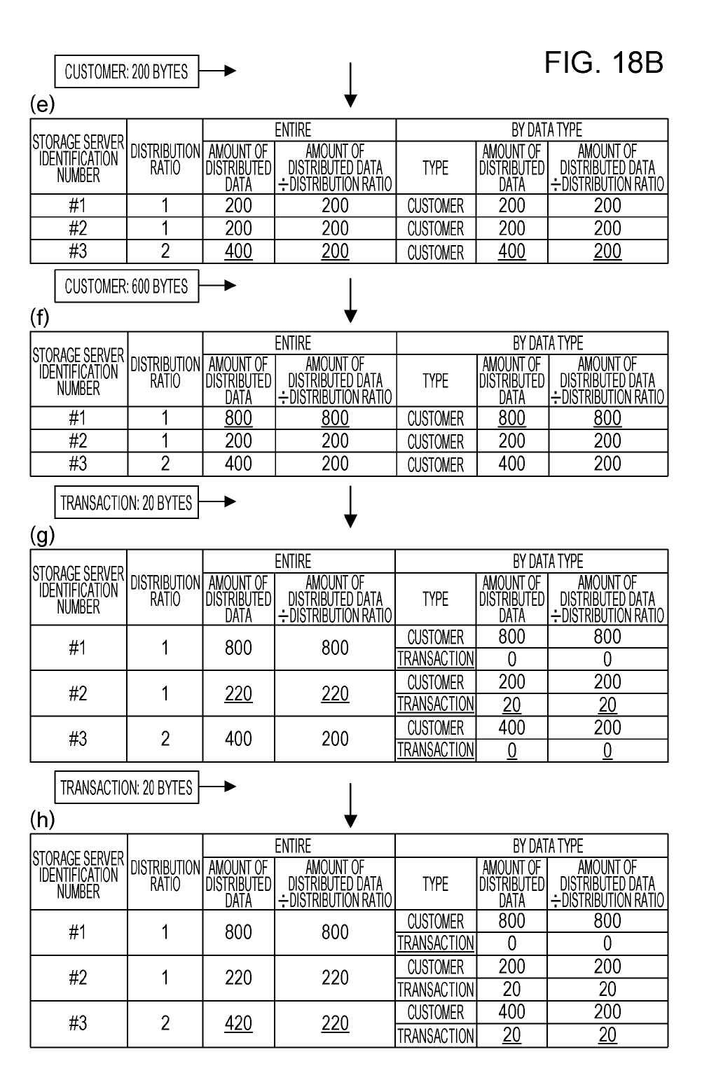

FIG. 18A and FIG. 18B are diagrams illustrating a second example of the storage process. FIG. 18A and FIG. 18B illustrate an example of performing a storage process illustrated in FIG. 14 in which the processing capabilities of the storage servers 2 are taken into account. In addition, the acceptable threshold of the data difference used in the process in step S202 is assumed to be 300 bytes.

FIG. 18A and FIG. 18B illustrate transitions of management information and the type and amount of data to be stored. The management information illustrated in FIG. 18A and FIG. 18B includes items of Identification number of the storage server 2, Distribution ratio, Entire, and By data type. The item of Entire includes the amounts of distributed data and the values of “the amount of distributed data÷the distribution ratio” for the entire data. The item of By data type includes the respective amounts of distributed data of individual data types and the values of “the amount of distributed data÷the distribution ratio” for individual types of data.

The management information illustrated in (a) indicates a state in which no data is stored in any storage server 2. It is then assumed that the management server 1 has acquired 200 bytes of customer data. There is no data of the target type (No in step S201), and therefore the process in step S204′ is performed. In the process in step S204′, the values of “the amount of distributed data÷the distribution ratio” of all of the storage servers 2 are zero, and therefore, in the present embodiment, the identification unit 14 identifies the storage server 2 (#1) with the smallest identification number as the storage destination. Then, the management information becomes a state illustrated in (b).

It is then assumed that the management server 1 has acquired 200 bytes of customer data. There is data of the target type (Yes in step S201) and the storage server 2 in which the data difference is greater than or equal to the acceptable threshold is not present (No in step S202), and therefore the process in step S203′ is performed. In step S203′, either of the storage server 2 (#2) and the storage server 2 (#3) in which the values of “the amount of distributed data÷the distribution ratio” are smallest is identified as the storage destination. In the present embodiment, the identification unit 14 identifies the storage server 2 (#2) with a smaller identification number as the storage destination. Then, the management information becomes a state illustrated in (c).

It is then assumed that the management server 1 has acquired 200 bytes of customer data. There is data of the target type (Yes in step S201) and the storage server 2 in which the data difference is greater than or equal to the acceptable threshold is not present (No in step S202), and therefore the process in step S203′ is performed. In step S203′, the identification unit 14 identifies the storage server 2 (#3) in which the value of “the amount of distributed data÷the distribution ratio” of the target type is smallest, as the storage destination. Then, the management information becomes a state illustrated in (d).

It is then assumed that the management server 1 has acquired 200 bytes of customer data. There is data of the target type (Yes in step S201) and the storage server 2 in which the data difference is greater than or equal to the acceptable threshold is not present (No in step S202), and therefore the process in step S203′ is performed. In step S203′, the value of “the amount of distributed data÷the distribution ratio” of the target type is smallest in the storage server 2 (#3), and therefore the identification unit 14 identifies the storage server 2 (#3) as the storage destination. Then, the management information becomes a state illustrated in (e).

It is then assumed that the management server 1 has acquired 600 bytes of customer data. There is data of the target type (Yes in step S201) and the storage server 2 in which the data difference is greater than or equal to the acceptable threshold is not present (No in step S202), and therefore the process in step S203′ is performed. In step S203′, all of the storage servers 2 have the same value of “the amount of distributed data÷the distribution ratio” for the target type. In the present embodiment, the identification unit 14 identifies the storage server 2 (#1) with the smallest identification number as the storage destination. Then, the management information becomes a state illustrated in (f).

It is then assumed that the management server 1 has acquired 20 bytes of transaction data. There is no data of the target type and therefore the determination result in step S201 is No, and the process in step S204′ is performed. In step S204′, the storage servers 2 having the smallest value of “the amount of distributed data÷the distribution ratio” for the entire data are the storage server 2 (#2) and the storage server 2 (#3). In the present embodiment, the identification unit 14 identifies the storage server 2 (#2) with the smallest identification number as the storage destination. Then, the management information becomes a state illustrated in (g).

It is then assumed that the management server 1 has acquired 20 bytes of transaction data. There is data of the target type (Yes in step S201) and the determination in step S202 is performed. The difference in the entire amount of data between the storage server 2 (#1) and the storage server 2 (#2) or between the storage server 2 (#1) and the storage server 2 (#3) is greater than or equal to 300 bytes, which is the acceptable threshold, and therefore the determination result in step S202 is Yes and the process in step S204′ is performed. In step S204′, the identification unit 14 identifies the storage server 2 (#3) having the smallest value of “the amount of distributed data÷the distribution ratio” for the entire data as the storage destination. Then, the management information becomes a state illustrated in (h).

Example of Hardware Configuration of Management Apparatus

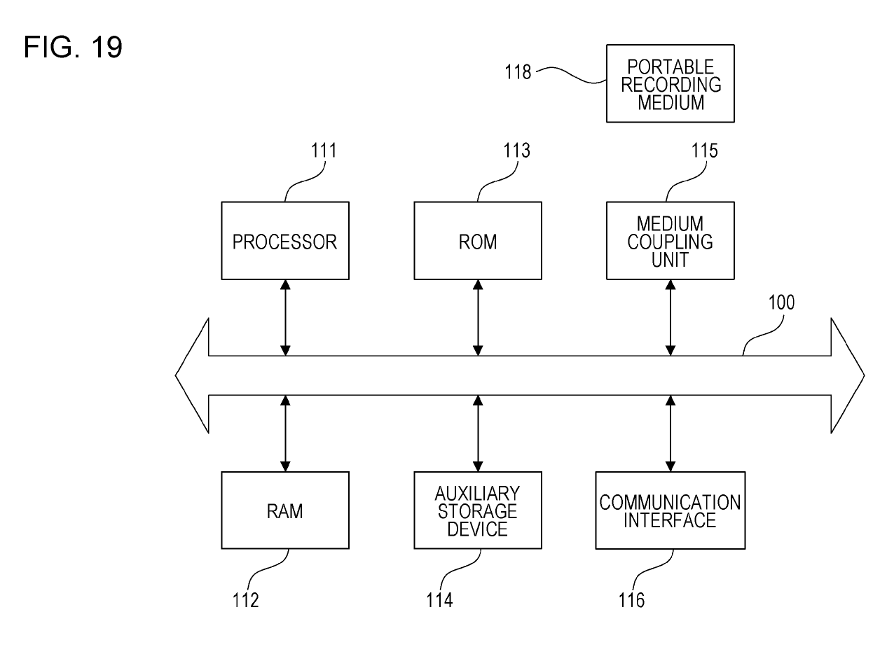

Next, with reference to the example in FIG. 19, a hardware configuration of the management server 1 or the storage server 2 will be described by way of example. As illustrated in the example in FIG. 19, a processor 111, a random access memory (RAM) 112, and a read only memory (ROM) 113 are coupled to a bus 100. An auxiliary storage device 114, a medium coupling unit 115, and a communication interface 116 are also coupled to the bus 100.

The processor 111 executes a program loaded into the RAM 112. As the program to be executed, a management program for performing processing in the embodiment may be applied.

The RAM 113 is a nonvolatile storage device in which a program to be loaded into the RAM 112 is stored. The auxiliary storage device 114 is a storage device that stores therein various types of information, and, for example, a hard disk drive, a semiconductor memory, or the like may be applied to the auxiliary storage device 114. The auxiliary storage device 114 may store therein a program to be loaded into the RAM 112. The medium coupling unit 115 is provided to be capable of being coupled to the portable recording medium 118.

As the portable recording medium 118, a portable memory, an optical disc (for example, a compact disc (CD) or a digital versatile disc (DVD)), a semiconductor memory, or the like may be applied. A management program for performing processing in the embodiment may be recorded on the portable recording medium 118.

The management information storage unit 12 illustrated in FIG. 2 and the data storage unit 23 illustrated in FIG. 4 may be implemented by the RAM 112, the auxiliary storage device 114, and the like. The first communication unit 11 illustrated in FIG. 2 and the second communication unit 21 illustrated in FIG. 4 may be implemented by the communication interface 116. The determination unit 13, the identification unit 14, the update unit 15, and the search control unit 16 illustrated in FIG. 2 may be implemented by a given management program executed by the processor 111. The search processing unit 22 illustrated in FIG. 4 may be implemented by the given management program executed by the processor 111.

All of the RAM 112, the ROM 113, the auxiliary storage device 114, and the portable recording medium 118 are examples of a computer-readable tangible recording medium. These tangible storage media are not temporary media such as signal carrier waves.

Others

The present embodiment is not limited to the embodiment described above and various configurations and embodiments may be employed without departing from the gist of the present embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
obtaining a type of updated data, included in pieces of data, to be updated in a database, the database storing the pieces of data corresponding to a plural kinds of types of data distributively in a plurality of storage devices;
determining a specified storage device, from among the plurality of storage devices, to store the updated data based on management information that indicates an amount of data for each of the plural kinds of types and for each of the plurality of storage devices;
storing the updated data into the specified storage device; and
updating the management information upon the storing the updated data.

2. The non-transitory computer-readable recording medium according to claim 1, wherein
the plural kinds of types represent a unit used for filtering data in a data searching based on a query to the database.

3. The non-transitory computer-readable recording medium according to claim 1, wherein
an update of the update data includes at least one of a registration of new data and update of already stored data in the database.

4. The non-transitory computer-readable recording medium according to claim 1, wherein the process further comprises:
transmitting, in response to an obtained search request for the pieces of data in the database, information including an instruction to perform a data search corresponding to the obtained search request in parallel.

5. The non-transitory computer-readable recording medium according to claim 1, wherein
the determining determines the specified storage device based on the management information so that amounts of data of the plurality of storage devices for each of the plural kinds of types get closer to equal.

6. The non-transitory computer-readable recording medium according to claim 1, wherein
the determining determines the specified storage device based on the management information and processing performances of the plurality of storage devices.

7. The non-transitory computer-readable recording medium according to claim 5, wherein
the determining determines the specified storage device based on the management information so that total amounts of data of the plurality of storage devices get closer to equal when an amount of data of any storage device among the plurality of storage device is larger than an amount of data of at least one storage device other than the any storage device by an amount greater than or equal to a threshold amount.

8. The non-transitory computer-readable recording medium according to claim 6, wherein
the determining determines the specified storage device based on total amounts of data of the plurality of storage devices and processing performances of the plurality of storage devices.

9. A management method executed by a computer, the management method comprising:
obtaining a type of updated data, included in pieces of data, to be updated in a database, the database storing the pieces of data corresponding to a plural kinds of types of data distributively in a plurality of storage devices;
determining a specified storage device, from among the plurality of storage devices, to store the updated data based on management information that indicates an amount of data for each of the plural kinds of types and for each of the plurality of storage devices;
storing the updated data into the specified storage device; and
updating the management information upon the storing the updated data.

10. A management apparatus comprising:
a memory; and
a processor coupled to the memory and the processor configured to execute a process, the process comprising:
obtaining a type of updated data, included in pieces of data, to be updated in a database, the database storing the pieces of data corresponding to a plural kinds of types of data distributively in a plurality of storage devices;
determining a specified storage device, from among the plurality of storage devices, to store the updated data based on management information that indicates an amount of data for each of the plural kinds of types and for each of the plurality of storage devices;
storing the updated data into the specified storage device; and
updating the management information upon the storing the updated data.
